(19) United States
(12) Patent Application Publication
(10) Pub. No.: US 2007/0166659 A1
(43) Pub. Date: Jul. 19, 2007

(54) THERMALLY ACCELERATED DENTAL IMRESSIONS

(76) Inventors: Michael A. HAASE, St. Paul, MN (US); Joel D. Oxman, Minneapolis, MN (US); Terry L. Smith, Roseville, MN (US); Ingo W. Wagner, Woerthsee (DE)

Correspondence Address: 3M INNOVATIVE PROPERTIES COMPANY, PO BOX 33427, ST. PAUL, MN, 55133-3427, US

(21) Appl. No.: 11/275,590

(22) Filed: Jan. 18, 2006

(51) Int. Cl. A61C 9/00

(52) U.S. Cl. 433/37

(57) ABSTRACT

A dental impression tray includes a body having a channel for receiving a quantity of curable thermoset dental impression material and an electrically resistive heating element provided within the channel, in order to use heat to accelerate the curing of the dental impression material. In some embodiments, the tray includes a liner positioned on the heating element in the channel, where the liner has low thermal conductivity. A system for forming a dental impression includes a quantity of thermoset dental impression material, and the tray. A method for using the tray includes the step of turning on the heating element after the tray is positioned within a patient's mouth, to accelerate the curing of the dental impression material.

### BACKGROUND OF THE INVENTION

This invention relates to a dental impression tray especially adapted for use with impression materials that cure more rapidly when heated.

Dental impression trays are used to hold impression material for making a model of a patient's tooth and oral tissue anatomy so that a crown, bridge, denture, veneer, restoration or the like can be made. A typical procedure involves placing a quantity of impression material in an open trough or channel of the tray and then pressing the tray onto the dental arch of the patient. The impression material is allowed to cure while in the oral cavity. The tray with the impression material is then removed from the oral cavity, and the impression material is used to prepare a positive model that replicates the selected area of the patient's arch.

Most conventional dental impression materials are made by mixing two components immediately before the impression is taken. Mixing of the components initiates a polymerization reaction that eventually causes the material to harden and cure. Consequently, as soon as the components are mixed, it is important for the dental practitioner to promptly deliver the tray to the oral cavity and accurately position the impression material relative to the selected area of the dental arch so that an accurate impression can be made.

Typically, a manufacturer of dental impression material provides recommended guidelines to the practitioner that specify both a working time and a oral setting time to be followed when using the material. The working time is determined by the composition of the polymeric system and is the total time allowed for mixing the components, placing the mixed components in the tray, delivering the tray to the oral cavity and accurately seating the impression material onto desired areas of the patient's dental arch. The oral setting time relates to the degree of curing of the impression material, and represents the time that should elapse (after the tray is seated) before the tray is removed from the oral cavity in order to ensure that the impression material has cured to a degree sufficient that the impression will not be distorted as the tray is removed from contact with the dental arch.

A variety of dental impression materials are currently available that polymerize upon mixing of two components. Such materials include, for example, alginate polysulfides, polyethers and silicones. Recommended working times for such materials are often in the range of about 1.25 to 7 minutes. Recommended oral setting times are often in the range of about 1.5 to 10 minutes.

In many impression materials that cure upon mixing, the length of the working time and the oral setting time are determined by the amount of catalyst in the mixture. As a consequence, one who attempts to decrease the oral setting time by increasing the catalyst concentration may be frustrated because the working time may also be unduly shortened. Conversely, an attempt to increase the working time may result in lengthening the oral setting time by an unsatisfactory amount.

A dental impression tray with the ability to heat and cool dental impression material is described in U.S. Pat. No. 1,084,017 to Lautenburg, which describes a process of using a heater within the dental impression tray to soften modeling compound, then taking the impression, then cooling the tray using a water jacket so that the modeling compound hardens.

Dental impression systems are desired that can work with impression materials that cure irreversibly to achieve a shorter oral setting time for the dental impression material, especially if possible without a reduction in the working time. Optically cured impression processes have been proposed, as described in U.S. Pat. No. 5,487,662 to Kipke et al., which is incorporated by reference herein. Further options for dental impression systems are desired.

### SUMMARY OF THE INVENTION

A dental impression tray is described herein including a body having a channel for receiving a quantity of curable thermoset dental impression material. The tray also includes an electrically resistive heating element including a flexible polymer substrate and an electrically resistive material.

One embodiment of a dental impression tray includes a body having a channel for receiving a quantity of thermally-accelerated curable dental impression material, the channel defined by at least a floor and a sidewall, wherein the channel includes an interior surface that faces the teeth when the body is in a mouth of a patient. An electrically resistive heating element is provided on at least a portion of the interior surface of the channel. A liner positioned on the heating element is included in some embodiments, where the liner is positioned on the heating element in the channel and is an electrical insulator.

A system for forming a dental impression includes a quantity of thermoset dental impression material. Thermoset dental impression material is capable of being irreversibly cured and its curing process is accelerated by heat. The system also includes a tray with a body having a channel for receiving the quantity of dental impression material, where the channel includes an interior surface that faces the teeth when the body is in a mouth of a patient. The system also includes a heating element provided on at least a portion of the interior surface of the channel.

One method of curing dental impression material is described including the steps of providing a dental impression tray with a body having a channel and a heating element provided on at least a portion of an interior surface of the channel, placing a quantity of curable dental impression material in the channel, and placing the tray in a patient's mouth. After placing the tray in the patient's mouth, another step is heating the heating element to speed the curing of the dental impression material.

The invention may be more completely understood by considering the detailed description of various embodiments of the invention that follows in connection with the accompanying drawings.

### BRIEF DESCRIPTION OF THE DRAWINGS

FIG. 1a is a bottom view of a dental impression tray of the present invention.

FIG. 1b is a top view of the dental impression tray of FIG. 1a.

FIG. 2 is a perspective exploded view of the dental impression tray of FIG. 1a, illustrating a liner, a heating element and a dental tray body.

FIG. 3a shows a cross sectional view of the dental impression tray of FIG. 1.

FIG. 3b shows a cross sectional view of an alternative dental impression tray.

FIGS. 4a and 4b illustrate manufacturing steps for the heater element of the dental impression tray of FIG. 1.

FIG. 5 illustrates an alternative heating element for a dental impression tray.

FIG. 6 illustrates a dental impression system including a heated dental impression tray and a control module.

While the invention may be modified in many ways, specifics have been shown by way of example in the drawings and will be described in detail. It should be understood, however, that the intention is not to limit the invention to the particular embodiments described. On the contrary, the intention is to cover all modifications, equivalents, and alternatives following within the scope and spirit of the invention as defined by the claims.

### DETAILED DESCRIPTION OF THE PREFERRED EMBODIMENT

The present invention is applicable to dental impression trays and systems and methods for taking a dental impression, and is particularly applicable to dental impression trays, systems and methods using an impression material that cures irreversibly and does so more rapidly when heated. For example, the invention is especially applicable to dental impression trays, systems and methods using silicone dental impression materials, including polyvinylsiloxane or polysiloxane impression materials.

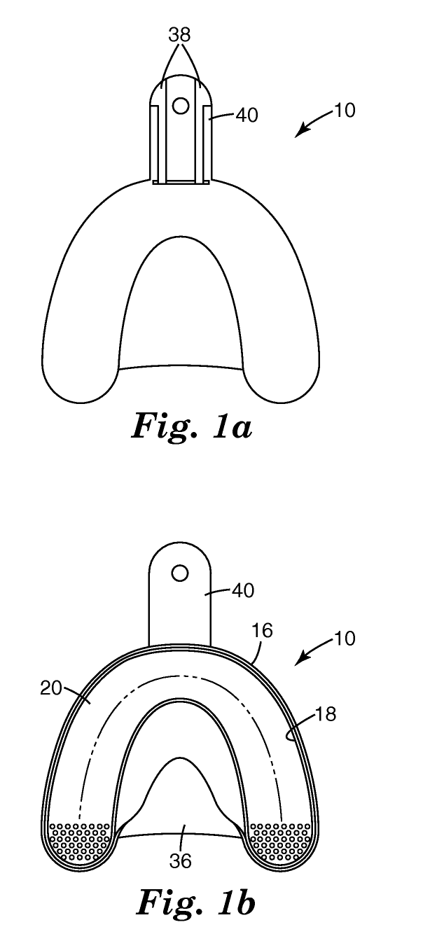

Now referring to FIGS. 1a, 1b, 2 and 3a, a dental impression tray 10 includes a heating element 14 for heating dental impression material to cause it to cure faster. During the use of this tray 10, the heating element 14 is activated after the tray 10 and impression material are within the patient's mouth in order to accelerate the curing of the impression material. As a result, it is possible to shorten the time that a patient spends with the tray in his or her mouth waiting for the material to cure, without shortening the working time during which the dental professional mixes and positions the impression material. The heating element 14 is sandwiched between a body 16 and a liner 18. In this particular example, the heating element 14 is an electrically resistive heating element, though many different types of heating elements may be used, as will be described further herein.

The body 16 defines a channel 20 that is shaped to receive a patient's dental arch. During use, the channel 20 receives a quantity of dental impression material, so that when the dental impression tray 10 is properly seated, the dental impression material conforms to the shape of the patient's dental arch or a portion of it. The heating element is activated after the dental impression tray is positioned in the patient's mouth, to speed the curing process of the dental impression material. As a result, the setting time is shortened with no impact on the working time for a given material.

The channel 20 includes a floor 24 and two sidewalls 28, 30. The sidewalls 28, 30 are generally approximately vertically oriented while the floor 24 connects the two sidewalls. The heating element 14 is positioned adjacent to at least a portion of the floor 24 of the channel and at least a portion of at least one of the side walls 28, 30 to heat the dental impression material.

Dental impression materials, including polyvinylsiloxane materials, typically have low thermal conductivity (for example, about 0.3-0.6 W/K-m). Therefore, heat generated at the surface of a dental tray may require a significant amount of time to diffuse throughout the impression material. By providing a heater that is positioned adjacent to significant portions of the tray surface (both floor and sidewalls) the required time to heat and therefore to cure can be minimized.

The liner 18 is made of a mesh polymer structure in the example illustrated in FIGS. 1-3. Small openings 34 are present over the entire surface of the liner 18, though they are only illustrated for simplicity at the ends of the channel 20. The liner serves to prevent dental or gingival surfaces from contacting the heating element and insulates the patient from too-close exposure to the heating element over too wide an area of dental tissue, which could be uncomfortable. In this example, the liner also serves to electrically insulate the heating element from contact with the dental or gingival surfaces. Yet another function of this particular liner 18 is that it helps retain the dental impression material in the tray because the dental impression material insinuates itself into the small holes in the liner 18. Additional examples of liners will be further discussed herein.

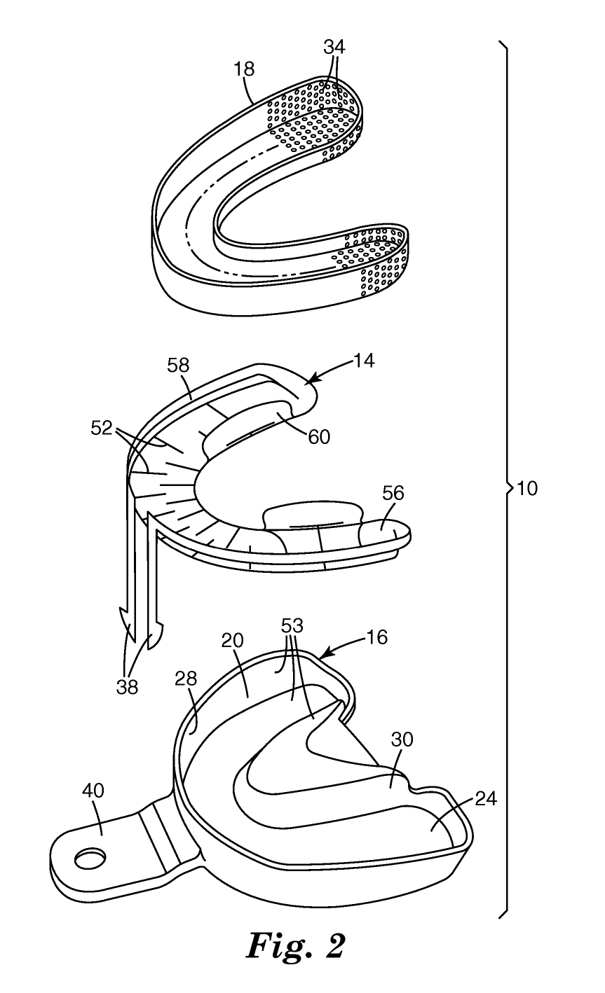

As seen in FIGS. 1a and 2, electrical leads 38 of the heating element 14 are positioned on the handle 40, so that they can be connected with a power source at the handle 40, to provide power to the heating element.

The body 16 of the tray 10 is typically a plastic molded structure. The example of FIGS. 1A and 1B includes a palate section 36. In other embodiments, the body 16 does not include a palate section 36.

### Heating Element Examples

In the embodiment illustrated in FIGS. 1a-3a, the heating element includes a thin film of conductive material on a flexible polymer substrate. This flexible construction conforms to the channel 20. The flexible polymer substrate is polyimide in this example. Also in this example, the thin film of conductive material is a metal, more specifically, copper. In other embodiments, the thin film includes other metals such as aluminum, nickel, nickel-chromium alloy, tungsten, or chromium. In other embodiments, the thin film includes other conductive materials such as amorphous silicon, graphite, indium-tin oxide, ruthenium oxide, and tantalum nitride.

The heating element is stamped with a pattern of slits 52 that allow the heating element to conform to an interior surface 53 of the body 16. The interior surface 53 of the body 16 is the surface of the channel 20 that faces the patient's teeth when the tray is positioned in the mouth, and is illustrated in FIG. 2. The pattern of slits 52 of the heating element 14 is shaped so that it requires the current flowing through the metal layer to flow through and therefore heat the entire structure. The heating element 14 includes a floor portion 56 that will rest against the floor 24 of the body. In many embodiments, the heating element 14 will substantially cover the floor 24 of the body. For example, the heating element in some embodiments will cover 50% or more of the surface area of the floor. In other examples, the heating element will cover 75% or more of the surface area of the floor. In yet other examples, the heating element will cover 90% or more of the surface area of the floor.

The heating element also includes first and second sidewall portions 58, 60, which contact the first and second sidewall portions 28, 30 of the body 16, respectively. In many embodiments, the heating element 14 will cover 30% or more of the surface area of the first, outer sidewall. In another example, the heating element 14 will cover 50% or more of the surface area of the first sidewall. In yet another example, the heating element 14 will cover 75% or more of the surface area of the first sidewall.

Regarding the coverage of the second, inner sidewall, in many embodiments, the heating element will cover 10% or more of the surface area of the second sidewall. In other embodiments, the heating element will cover 20% or more of the surface area of the second sidewall. In yet other examples, the heating element will cover 30% or more of the surface area of the second sidewall.

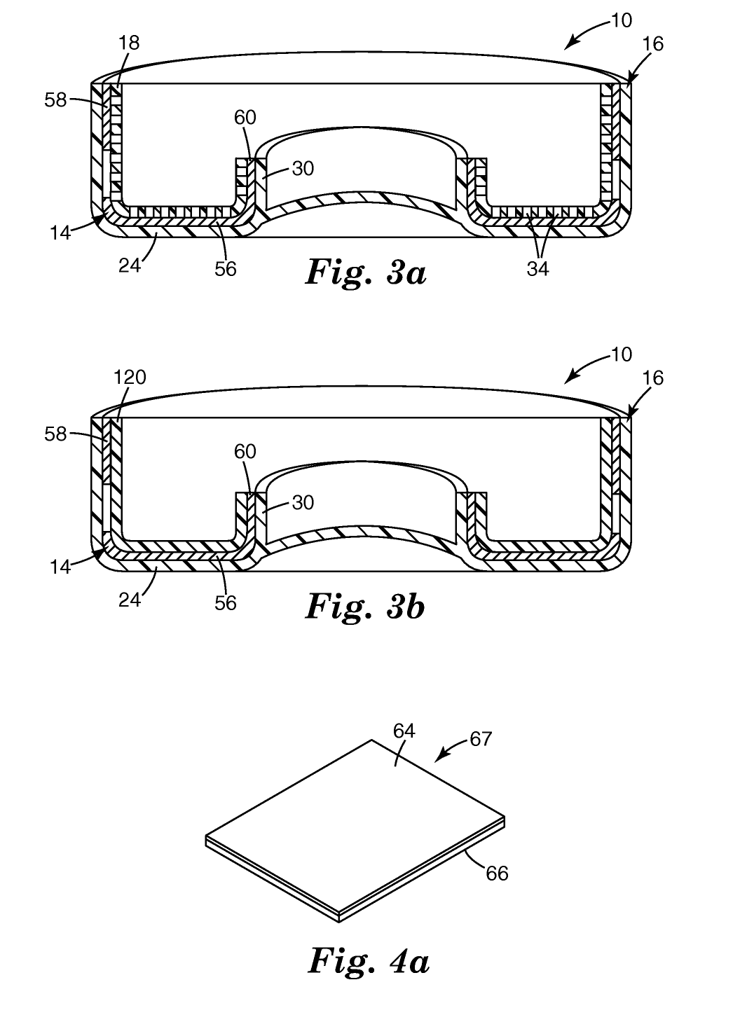

In one example, the polymer substrate is about 0.01 inch thick or less. In another embodiment, the polymer substrate is about 0.005 inch thick or less. In the example shown in FIG. 3, the polymer substrate is about 0.002 inch thick. In one embodiment, the metal layer is about 10 micrometers thick.

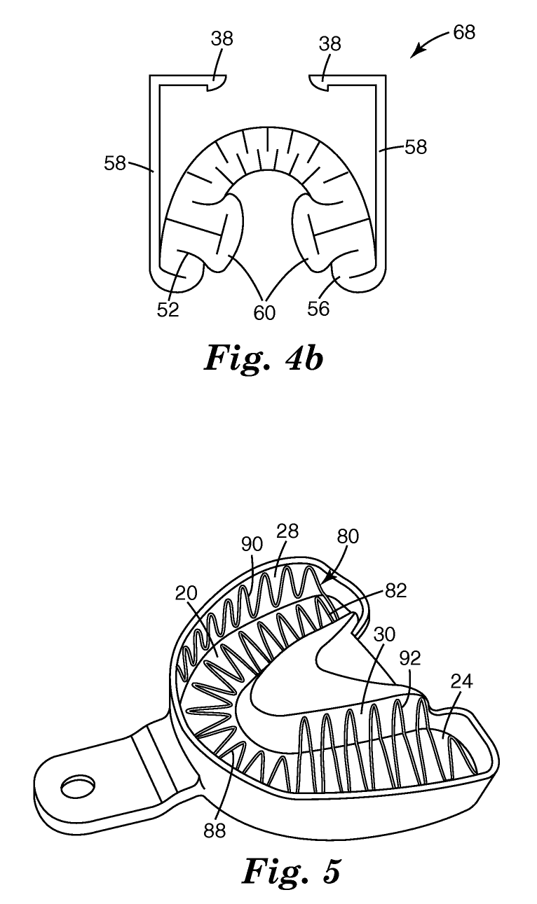

FIGS. 4a and 4b illustrate how the heating element 14 in the example of FIG. 2 is formed. First, a thin layer of metal 64 is coated onto a polymer substrate 66 to form a sheet 67, as shown in FIG. 4a. Next, the contour of the heating element, including a pattern of slits is stamped into the sheet 67 as shown in the top view of FIG. 4b. The resulting structure 68 is positioned against the interior surface 53 of the body 16. The pattern of slits requires current to flow through the entire structure and the slits also allow the heating element 14 to more closely conform to the interior surface 53.

Another possibility is for the conductive layer to be deposited directly onto the tray 10. Alternatively, the conductive layer can be deposited onto a liner shaped substantially similarly to the tray's channel that snaps into the tray. In one embodiment, this liner is removable without causing any damage to the tray so that the tray can be re-used. Such a liner would be very similar in configuration and appearance to the mating tray itself, though slightly smaller to allow it to snap into the tray. In another embodiment, the electrical path of the heater is patterned by structures, such as grooves, that are molded into the dental tray body or into the liner.

In another alternative for the heating element, a metal foil without a polymer substrate is positioned on the inner surface of the tray. In yet another alternative, a metal foil may be positioned directly onto a liner that may be removable.

FIG. 5 illustrates a wire heating element 80 which is another example of an electrically resistive heating element that can be used with the present invention. In the example shown in FIG. 5, the wire heating element 80 is positioned to bring heat to the floor 24, first sidewall 28 and second sidewall 30 of the channel 20, provided by, respectively, the floor portion 88, first sidewall portion 90 and second sidewall portion 92 of the wire heating element 80. To form the wire heating element, the wire 82 is shaped to travel over the desired portions of the surfaces of the channel 20 and is secured to the tray using any number of suitable methods, such as epoxy. In the example illustrated in FIG. 5, the wire 82 is placed directly in the channel 20 of the body of the dental impression tray. In another configuration not illustrated here, the wire heating element 80 includes a flexible polymer substrate that can be inserted into the dental impression tray.

Electrical heating elements suitable for use with the invention are not limited to the foil and wire configurations described so far. In one embodiment, a wire heating element is formed on a rigid tray that is removable. For one embodiment with an electrical heater, the heater has low electrical resistance, for example less than 5 Ohms. In other embodiments, the heater has electrical resistance less than 3 Ohms. In yet another embodiment, the heater has electrical resistance less than 1 Ohm. A heater with low electrical resistance facilitates high power operation at low voltages (for example, less than 4 Volts), which reduces or eliminates the risk of the patient feeling any shock. Also, in one example, the tray 10 includes fuses to protect from excessive power or high temperatures.

In one example, the metal layer is a copper layer that is coated onto a polyimide foil. The polyimide foil is available from E.I. DuPont de Nemours and Company Corporation as Kapton® foil. The sheet resistivity of the metal layer in this embodiment is 5.5 mOhm/square. In other embodiments, the sheet resistivity of the metal layer is 15 mOhm/square or less, 10 mOhm/square or less, and 5 mOhm/square or less.

The heating element is not limited to an electrical heater. Other suitable heating elements are used in certain embodiments. In other examples of a heated dental impression tray, the heating element includes hot liquid forced through channels in the tray, an exothermic chemical reaction, radiofrequency radiation, light, such as from a laser, or ultrasound vibrations.

### Dental Impression Materials

Many different dental impression materials cure irreversibly and have a shorter cure time when heated, making them appropriate for use with a heated dental tray. These dental impression materials will be referred to as thermoset dental impression materials. In addition, dental impression materials will likely be developed in the future that cure even more rapidly upon exposure to heat. In discussing particular examples of dental impression materials for use with a heated dental tray, it is helpful to consider the major chemical classes of elastomeric impression material. For example, the book “Impressions: A Text for Selection of Materials and Techniques” describes in Chapter 2, seven major chemical classes of dental impression material as follows: Irreversible hydrocolloid (alginate), reversible hydrocolloid, polysulfide (rubber base), polyether, condensation reaction silicones, addition reaction silicones (polyvinylsiloxanes), and light cured impression materials. HARRY F. ALBERS, D.D.S., IMPRESSIONS: A TEXT FOR SELECTION OF MATERIALS AND TECHNIQUES (Alto Books 1990) (pp. 25-40).

The list of categories includes two silicones distinguished by their chemical reactions as condensation and addition types. Addition reaction silicones, or polyvinylsiloxanes, are currently the most commonly used class of dental impression materials. These materials are accurate and stable. For many of the materials within this class, raising the temperature of the dental impression material causes a reduction in cure time. Some examples of an addition reaction silicone materials that showed faster curing with added heat during experiments are 3M's Imprint II Garant® Quickstep Heavy Body material and 3M's Imprint II Garant® Monophase Medium Body material, as will be discussed further herein.

Condensation reaction silicones, or polysiloxanes, are known to be accurate and easy to work with, though not as dimensionally stable as addition reaction silicones. Condensation reaction silicones also have a reasonable working time of 5-7 minutes. The cure time of typical condensation reaction silicone materials will be reduced by raising the temperature of the system.

Polysulfides, or rubber base material, are two-component systems that have an initial setting reaction and a later setting stage. Heating a polysulfide dental impression material speeds the setting process.

Polyether dental impression materials are formed from combining a base and catalyst paste. These compositions are hydrophilic. Only a modest improvement in curing time would be achieved by heating most examples of polyether dental impression materials during curing.

Alginates are stored in powder-form and are then mixed with water to create a semi fluid state. Alginates are not detailed enough to use for many applications. However, if alginates are used, the cure time of an alginate would be increased by heating the impression tray.

### Liners

In many examples of the invention, a liner or standoff structure is included as an inner component of the dental impression tray. The purpose of the liner is to prevent the patient from feeling an uncomfortable level of heat. The liner ensures an appropriate space is maintained between the heating element and the patient's teeth and gums. The liner structure 18 is made of a material that is electrically and thermally insulating. In one example, the liner structure has a value for thermal conductivity that is lower or equal to the value for thermal conductivity of the dental impression material. For example, the thermal conductivity of the liner material is typically less than 1 W/K-m and more typically is less than 0.2 W/K-m. In one embodiment, the liner structure has a value for electrical conductivity that is lower or equal to the value for electrical conductivity of the dental impression material. For example, the electrical conductivity of the liner material is typically less than 2×10⁻⁶ S/m, and more typically is less than 10⁻¹² S/m.

In the example of FIGS. 1a to 3a, the liner 18 is a polymer mesh screen. The small openings 34 in the liner allow for a greater degree of heating of the dental impression material, and also provide a structure in which the dental impression material can embed itself.

Another example of a liner structure is shown in cross-section in FIG. 3b, where a solid polymer structure serves as the liner 120. Another example of a liner structure is a woven polymer screen, or piece of non-woven material. The polymer screen or non-woven materials provide spaces within the fibers of the liner for the dental impression to grip. Examples of non-woven materials that are suitable for use with dental trays are discussed in U.S. Pat. Nos. 6,875,016 and 5,415,544, which are hereby incorporated herein by reference.

Other alternative liner structures include polymer standoffs positioned on the conductive material of a heating element and a thin, electrically insulating polymer sheet. In some embodiments, the liner is attached on top of the heating element within the tray. In other embodiments, the liner is attached to the heating element before the heater is installed in the tray. In yet other embodiments, standoffs are formed in the tray first, and the heating element is placed only in the area between the standoffs.

### Dental Impression Control System

A dental impression system that includes an electrically resistive heater also includes an electrical connection to the heating element, a power source and a control module. As discussed above, an electrically resistive heating element may be connected to a power source via electrical leads 38. In one example, the leads are integrated into the structure of the flexible substrate of the heating element. In this example, the leads may be plated with thicker metal to minimize power dissipation in the leads themselves. This option eliminates the need to solder wires to the tray, which is another way of making the electrical connection to the heating element.

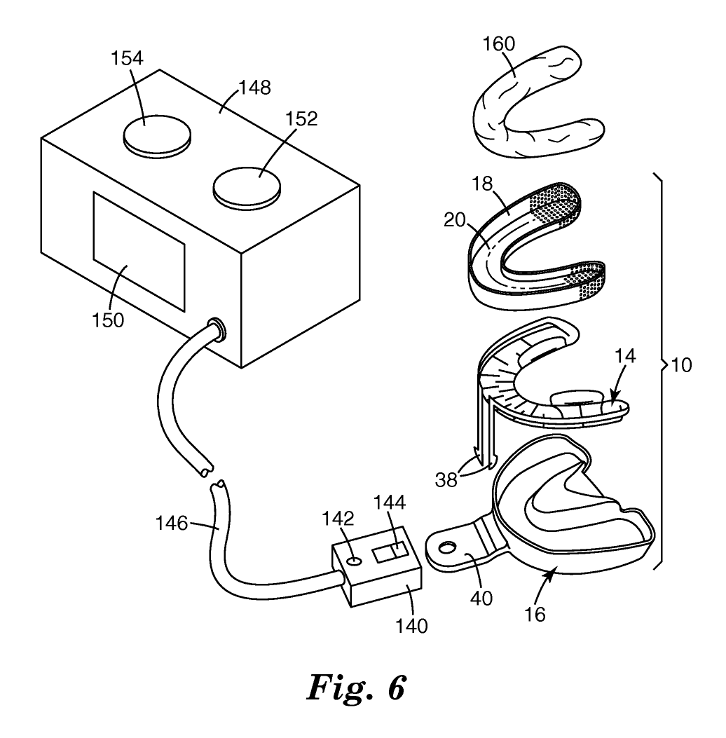

FIG. 6 illustrates the dental impression tray 10 in the context of a system for taking a dental impression using impression material 160. A connector 140 is shaped to receive the handle 40 and establish an electrical connection with the leads 38. FIG. 6 includes an exploded view of the dental impression tray 10 including the leads 38, where the leads 38 are shown extending downwardly from the heating element 14. When the dental impression tray is assembled, the leads will be positioned along the lower side of the handle 40, as shown in FIG. 1a.

The connector 140 includes an indicator light 142 and an on/off switch 144. In this example, the indicator light 140 may be off or may display one of three different colors, red, amber and green, to reflect a heating, curing and finished state. In other examples of the invention, the indicator light colors represent different states and different colors are utilized.

A cable 146 connects the connector 140 and tray 10 to the control module 148. The control module 148 includes a display 150 and on and off switches 152, 154. In this example, the display 150 shows the status of the system as either heating to the desired temperature, curing at the desired temperature or ready for operation. The display 150 also includes a timer display for showing the elapsed time since the heating element 14 was powered up, or the time remaining before the dental impression material is cured. In one example, the control module 148 indicates when a certain amount of time has passed or when the heating element is at the desired temperature by issuing an audible alert.

The display 150 also includes a temperature display in one example for indicating the temperature at a location within the tray. The temperature is determined with a temperature sensor at a location in the tray in one example. Possible locations for a sensor in the tray include on the conductive layer of the heating element, within the dental impression material, or on the tray. In another example, the temperature is calculated from the power delivered to the heater and the heat capacity and thermal conductivity of the tray and impression material. The controller in one example is capable of adjusting the countdown timer display in order to increase the curing time if the power is shut down before curing is complete. The control module 148 is integrated into a larger multi-functional console in one embodiment, to achieve space savings and convenience.

In one embodiment, the heater is capable of generating high power, for example, greater than 10 W, greater than 20 W, or even greater than 30 W. The tray and impression material may thereby be quickly brought up to a target temperature, and the power can then be reduced or turned off.

Another feature of the system in one embodiment is a hollow sleeve of material, such as plastic, positioned over the connector and cable, to protect the system from contamination by the patient with saliva. This sleeve may be disposable.

### Method of Use

Methods of using a dental impression system with a heated dental impression tray will now be described. Referring to the dental impression system example of FIG. 6, the connector 140 is attached to the tray 10 at the handle 40, thereby establishing an electrical connection between the leads 38 and the control and power module 148. In other embodiments using heating elements without an electrically resistive heater, the system is connected so that the heating element is ready to operate.

Next, the impression material, such as a polyvinylsiloxane, for example 3M's Imprint II Garant® material, is prepared for use. The typically two components of the impression material are mixed together and placed into the channel 20 of the tray 10. Then the tray 10 is placed into the patient's mouth to receive the impression of the desired oral tissues, ranging from a single tooth to an entire dental arch.

Then, the heating element of the tray is activated to speed the curing process of the dental impression material. The heating element is activated by using either the on button 154 on the control module 148 or the on/off switch on the connector 140, in the example of the FIG. 6. The display 150 of the control module 148 displays the time that has elapsed since the heating element was activated, or the time remaining before the impression material is cured.

The display 150 also shows a temperature of the tray, either using a temperature sensor within the tray or the temperature is calculated from the power delivered to the heater and the heat capacity and thermal conductivity of the tray and impression material. As mentioned earlier, possible locations for a sensor in the tray include on the conductive layer of the heating element, within the dental impression material, or on the tray.

The display 150 also shows the status of the heating and curing process, such as heating, curing or ready. In some embodiments, the display 150 shows only a subset of the pieces of information mentioned with respect to FIG. 6. In other embodiments, additional pieces of information are visible on the display.

In the example of FIG. 2, the heating element 14 reaches up to cover at least a portion of the first sidewall 28 and second sidewall 30 of the channel 20, as well as covering at least a portion of the floor 24 of the channel. By heating all three sections of the interior surface 53 of the tray 10, the system minimizes the distance that the heat must diffuse through the dental impression material.

The tray 10 remains in the patient's mouth to allow the impression material to cure. When an appropriate time has passed or a specific temperature is reached, the system either emits an audible alert, discontinues power to the heating element or both.

When the impression material has cured and the power is turned off, the tray and impression material are removed from the patient's mouth. The impression is a negative reproduction of the tissues and by filling it with dental stone or other model material, a positive cast can be created. Casts of the mouth are used in evaluation and treatment of many different dental conditions.

In some embodiments, the heating element and tray are intended to be used a single time. In other embodiments, the heating element and tray are intended to be sterilized and reused. In another embodiment, the heating element is an insert that is added to an existing tray.

### Method of Manufacture

Methods of manufacture of a dental impression tray system will now be described. In the typical example, the tray itself is a plastic molded tray. The heating element is placed within the channel of the tray, and may cover only the floor of the channel or cover the floor of the tray and one or two sidewalls of the channel. The construction of a foil resistive heating element as shown in FIG. 2 is discussed above with respect to FIG. 4. The construction of a wire resistive heating element as shown in FIG. 5 is also discussed above with respect to FIG. 5. In addition, there are many other methods of producing the conductive layer of an electrically resistive heating element, including plating, vacuum thermal evaporation, vacuum e-beam evaporation, and sputtering, to name a few.

An electrically resistive heating element is secured to the channel 20 of the tray 10 using any of a number of suitable methods, such as epoxy. Then the liner structure, if any, is attached to the tray by any number of suitable means, including epoxy or a friction fit.

In some examples, the heating element and tray are intended to be used a single time, and the components can be permanently attached to each other. In other embodiments, the heater and tray are intended to be sterilized and reused, and again, the components can be permanently attached to each other. In other embodiments, the heating element is formed as a part of an insert that is sold to be added to an existing tray.

There are alternative manufacturing techniques to the procedure of securing the heating element to the tray using epoxy or other adhesive. For example, the electrically resistive heating element is a metal film formed on a carrier, which is then overmolded to form the tray. In this scenario, the carrier is either a polymer film or a rigid polymer structure. In another example, the electrically resistive heating element is a metal foil which is overmolded to form the tray. In another example, the polymer film on which the metal film or wire is present is a thermoplastic film, which can be thermoformed to fit the tray.

### Experimental Results

A heated dental impression system was tested using an arched quarter-inch tube to simulate teeth. The heating element was cut from 0.002 inch thick Kapton foil coated with copper, with a sheet resistivity of 5.5 mOhms/square. The foil was cut into a shape and pattern to fit into a plastic dental tray, and was attached to the floor of the dental tray using an epoxy. The heater covered substantially the entire floor of the tray, and large portions of the two sidewalls of the tray. Two different formulations of polyvinylsiloxane materials were tested using this tray: 3M's Imprint II Garant® Quickstep Heavy Body material and 3M's Imprint II Garant® Monophase Medium Body material. During the test, 11 Amps at 4.5 Volts (about 50 Watts) was applied to the heating element for 15 to 20 seconds. The temperature of a thermocouple imbedded in the impression material near the heater rose to 50 degrees C. during that time. The power was then turned off.

3M's Imprint II Garant® Monophase Medium Body material has a nominal cure time of 4 minutes. However, when the dental tray was heated to 50 degrees C. in the test described above, the material cured in 60 to 90 seconds.

3M's Imprint II Garant® Quickstep Heavy Body material has a nominal cure time of 2 minutes and 30 seconds. However, when the dental tray was heated to 50 degrees C. in the test, the material cured in 45 to 60 seconds.

In another experiment with 3M's Imprint II Garant® Quickstep Heavy Body material, the power was applied only long enough for the measured temperature to reach 40 degrees C. In this case, the material cured in about 60 seconds.

In another experiment using a volunteer and 3M's Imprint II Garant® Quickstep Heavy Body material, 45 Watts of power was applied for 30 seconds, and the tray remained in the mouth a total of 60 seconds. An accurate dental impression was achieved. Quickly raising temperature of the tray 10 to near or comfortably above body temperature was found to provide a significant reduction in the cure time for the tested dental impression materials.

The above specification provides a complete description of the structure and use of the invention. Since many of the embodiments of the invention can be made without parting from the spirit and scope of the invention, the invention resides in the claims.

We claim:

1. A dental impression tray comprising:
a body having a channel for receiving a quantity of thermoset dental impression material; and
an electrically resistive heating element including a flexible polymer substrate and an electrically resistive material positioned on the substrate.

2. The tray of claim 1 wherein the electrically resistive material is a metal film or metal wire.

3. The tray of claim 1 wherein the electrically resistive material comprises one of the group of copper, aluminum, nickel, nickel-chromium alloy, tungsten, chromium, amorphous silicon, graphite, indium-tin oxide, ruthenium oxide, and tantalum nitride.

4. The tray of claim 1, wherein the channel is defined by at least a floor and a first sidewall, wherein the heating element includes the electrically resistive material provided on at least a portion of the floor and at least a portion of the first sidewall of the channel.

5. The tray of claim 1 wherein the heating element includes a metal wire shaped into a pattern and bonded to the flexible polymer layer.

6. The tray of claim 4 wherein the heating element is present on substantially the entire floor.

7. The tray of claim 4 wherein the body further comprises a second sidewall, wherein the heating element is located on a surface of each of the first and second sidewall that will face the teeth when the tray is placed into a patient's mouth.

8. The tray of claim 1 wherein the heating element includes a support structure that fits within the tray, wherein the support structure is removable from the tray without damaging the tray.

9. A dental impression tray comprising:
a body having a channel for receiving a quantity of thermoset dental impression material, wherein the channel includes an interior surface that faces the teeth when the body is in a mouth of a patient;
an electrically resistive heating element provided on at least a portion of the interior surface of the channel; and
a liner positioned on the heating element in the channel, wherein the liner comprises a liner material, wherein the liner material is a thermal insulator.

10. The tray of claim 9 where the thermal conductivity of the liner material is less than 1 W/K-m.

11. The tray of claim 9, wherein the liner comprises one of the group of a molded plastic screen, a polymer sheet, a woven polymer screen, a non-woven polymer, and a sheet perforated by an array of holes.

12. The tray of claim 9, wherein the liner is configured to encourage retention of cured impression material in the tray.

13. A system for forming a dental impression comprising:
(a) a quantity of thermoset dental impression material, wherein the dental impression material is capable of being irreversibly cured and for which the curing process is accelerated by heat;
(b) a tray comprising:
(i) a body having a channel for receiving the quantity of dental impression material, wherein the channel includes an interior surface that faces the teeth when the body is in a mouth of a patient; and
(ii) a heating element provided on at least a portion of the interior surface of the channel.

14. The system of claim 13 wherein the heating element is an electrically resistive heating element.

15. The system of claim 13 wherein the dental impression material is a silicone material.

16. The system of claim 14 wherein the heating element is a metal foil positioned on a flexible polymer layer.

17. A method of curing dental impression material comprising the steps of:
(a) providing a dental impression tray comprising a body having a channel and a heating element provided on at least a portion of a interior surface of the channel;
(b) placing a quantity of curable dental impression material in the channel;
(c) placing the tray in a patient's mouth; and
(d) after placing the tray in the patient's mouth, heating the heating element to speed the curing of the dental impression material.

18. The method of claim 17 wherein the dental impression material is a polyvinylsiloxane or polysiloxane material.

19. The method of claim 17 further comprising the steps of:
(a) monitoring the temperature of one or more of the dental impression material, the tray or the heating elements; and
(b) stopping the heating process when one of the monitored temperatures reaches a certain temperature.

20. The method of claim 17 further comprising the steps of:
(a) providing a timer to countdown a predetermined cure time and provide an audible cue when the cure time expires.
